(19) United States
(12) Patent Application Publication
(10) Pub. No.: US 2013/0191124 A1
(43) Pub. Date: Jul. 25, 2013

(54) VOICE PROCESSING APPARATUS, METHOD AND PROGRAM

(71) Applicant: Sony Corporation, Tokyo (JP)

(72) Inventors: Hiroyuki HONMA, Chiba (JP); Toru CHINEN, Kanagawa (JP)

(73) Assignee: SONY CORPORATION, Tokyo (JP)

(21) Appl. No.: 13/722,117

(22) Filed: Dec. 20, 2012

(30) Foreign Application Priority Data
Jan. 25, 2012 (JP) 2012-012864

(51) Int. Cl. G10L 15/02

(52) U.S. Cl. CPC G10L 15/02
USPC 704/233

(57) ABSTRACT

Provided is a voice processing apparatus including a feature quantity calculation section extracting a feature quantity from a target frame of an input voice signal, a sound pressure estimation candidate point updating section making each frame of the input voice signal a sound pressure estimation candidate point, retaining the feature quantity of each sound pressure estimation candidate point, and updating the sound pressure estimation candidate point based on the feature quantity of the sound pressure estimation candidate point and the feature quantity of the target frame, a sound pressure estimation section calculating an estimated sound pressure of the input voice signal, based on the feature quantity of the sound pressure estimation candidate point, a gain calculation section calculating a gain applied to the input voice signal based on the estimated sound pressure, and a gain application section performing a gain adjustment of the input voice signal based on the gain.

### BACKGROUND

The present disclosure relates to a voice processing apparatus, method and program, and more specifically to a voice processing apparatus, method and program which can more easily obtain a voice of an appropriate level.

In the case where a conversation, a musical performance or the like is recorded by using a recording device, such as an IC (Integrated Circuit) recorder, it is important to correctly set a recording sensitivity, so that an input voice signal of a collected voice is recorded at an appropriately sized level.

For example, in the case where a conversation is recorded in a meeting conducted in a relatively large meeting room, if the recording sensitivity of a recording device is set low, there will be cases where voices will be recorded at such a low level that the conversation of distant speakers will hardly be able to be heard.

On the other hand, in the case where a microphone is brought close to someone's mouth and their dictation is preserved as a memo, if the recording sensitivity of a recording device is set high, a signal of a level exceeding an upper limit of what can be recorded will be input. In that case, sound distortion will occur in the recorded voice, and such a sound distortion will become a jarring noise.

In this way, in order to avoid a voice being recorded at an inappropriate level, generally the setting of the recording sensitivity in the recording device is roughly divided into 3 stage levels, and signal processing technology is used which automatically retains a signal level at a constant level. Such signal processing technology is called ALC (Auto Level Control) and AGC (Auto Gain Control).

For example, as shown in FIG. 1, the recording sensitivity in a recording device is divided into the three stages of high, medium and low, and values of +30 dB, +15 dB and 0 dB are allocated as amplification factors of an amplifier for these respective recording sensitivities.

Further, as shown in FIG. 2 for example, an input system of a general recording device includes a main control device 11, an amplifier 12, an ADC (Analog to Digital Convertor) 13, and an ALC processing section 14.

For such a recording device, when a user designates a setting of the recording sensitivity for the recording device, an amplification ratio, which has been determined by the recording sensitivity designated by the user, is set by the main control device 11 as an amplification factor in the amplifier 12.

Then, a collected voice signal is amplified by the amplification factor set in the amplifier 12, digitized by the ADC 13, and afterwards the signal level is controlled by the ALC processing section 14. Then, the signal with the controlled signal level is output from the ALC processing section 14 as an output voice signal, and the output voice signal is encoded and afterwards recorded.

For example, the signal shown by the polygonal line IC11 of FIG. 3 is input to the ALC processing section 14, and control of the signal level of this signal is performed. Then, the signal shown by the polygonal line OC11 obtained as a result of this is output from the ALC processing section 14 as a final output voice signal. Note that in FIG. 3, the horizontal axis shows time, and the vertical axis shows the signal level. Further, the dotted line in FIG. 3 shows the maximum input level, which is the maximum value of the values acquired as the level of the signal.

The signal denoted by the polygonal line IC11 is a signal which is input to a microphone of a recording device, amplified by the amplifier 12, and afterwards digitized by the ADC 13. Since a part of the level larger than the maximum input level, denoted by the dotted line, from among the recorded signals is recorded in a clipped state, a sound distortion noise will occur in such a section of the signal during reproduction.

Accordingly, a gain adjustment is performed in the recording device for the signal denoted by the input polygonal line IC11, and the signal obtained as a result of this and denoted by the polygonal line OC11 is output as an output signal. The level of this signal denoted by the polygonal line OC11 becomes less than the maximum input level at each time, and it is understood that gain adjustment is performed so that the output voice signal will be a signal of an appropriate level.

During gain adjustment, the signal level is measured in real time by the ALC processing section 14, and in the case where the signal level approaches the maximum input level, the gain is lowered so that the level of the signal does not exceed the maximum input level. Then, in the case where the level of the signal does not exceed the maximum input level, the gain is returned to 1.0.

As described above, setting of the recording sensitivity, and gain adjustment by the ALC processing section 14, are performed so as to avoid the occurrence of sound distortions and prevent the recorded voice from being too small to be heard. However, there are cases where the recorded voice will be difficult to hear during reproduction, due to the recording sensitivity not yet being appropriately set, and due to the sounds obtained by the ALC (gain adjustment) being unstable sounds by the influence of external noise or the like.

On the other hand, technology is proposed in Japan Patent No. 3367592, for example, which is related to an automatic gain adjustment device for reducing the influence of external noise as much as possible, and for recording a voice at an appropriate level.

In this technology, an auto-correction and the inclination of a power spectrum are calculated in a time frame, for correctly distinguishing a voice section, and in the case where either the auto-correction or the inclination of the power spectrum are less than a threshold, this time frame is considered to be non-steady. The voice is controlled to an appropriate level by excluding such a time frame, which is non-steady, that is, which is assumed not to be a voice section, from the calculation of the level of the input signal.

### SUMMARY

However, in the above described technology, in the case where a microphone is close to a sound source such as a telephone, while discriminating between a voice and a noise is easy, in the case where the recording device is placed in a large room and a speaker at a comparative distance talks, the SN ratio (Signal to Noise ratio) of the input voice signal will be bad, and a voice section will not be able to be detected accurately. Accordingly, there have been cases where a voice signal of an appropriate level is not able to be obtained as a recorded voice signal.

Further, auto-correction or the like is normally calculated for each of the time frames, and discriminating between a voice and an unsteady noise leads to an acceleration of battery consumption in compact recording devices, such as those driven by batteries.

The present disclosure has been made in view of such a situation, and can more easily obtain a voice of an appropriate level.

According to an embodiment of the present disclosure, there is provided a voice processing apparatus including a feature quantity calculation section which extracts a feature quantity from a target frame of an input voice signal, a sound pressure estimation candidate point updating section which makes each of a plurality of frames of the input voice signal a sound pressure estimation candidate point, retains the feature quantity of each sound pressure estimation candidate point, and updates the sound pressure estimation candidate point based on the feature quantity of the sound pressure estimation candidate point and the feature quantity of the target frame, a sound pressure estimation section which calculates an estimated sound pressure of the input voice signal, based on the feature quantity of the sound pressure estimation candidate point, a gain calculation section which calculates a gain applied to the input voice signal based on the estimated sound pressure, and a gain application section which performs a gain adjustment of the input voice signal based on the gain.

The feature quantity calculation section calculates a sound pressure level of the input voice signal, in at least the target frame, as the feature quantity. When the sound pressure level of the target frame is larger than a minimum value of the sound pressure level as the feature quantity of the sound pressure estimation candidate point, the sound pressure estimation candidate point updating section discards the sound pressure estimation candidate point having the minimum value, and makes the target frame a new sound pressure estimation candidate point.

The feature quantity calculation section calculates sudden noise information indicative of a likeliness of a sudden noise in at least the target frame, as the feature quantity. When the target frame is a section including the sudden noise based on the sudden noise information, the sound pressure estimation candidate point updating section does not make the target frame the sound pressure estimation candidate point.

When a shortest frame interval of frame intervals between adjacent sound pressure estimation candidate points is less than a predetermined threshold, the sound pressure estimation candidate point updating section discards the sound pressure estimation candidate point having a small sound pressure level from the adjacent sound pressure estimation candidate points having the shortest frame interval, and makes the target frame the new sound pressure estimation candidate point.

The predetermined threshold is determined in a manner that the predetermined threshold increases with passage of time.

The feature quantity calculation section calculates a number of elapsed frames, at least from the sound pressure estimation candidate point up to the target frame, as the feature quantity. When a maximum value of the number of elapsed frames of the sound pressure estimation candidate point is larger than a predetermined number of frames, the sound pressure estimation candidate point updating section discards the sound pressure estimation candidate point having the maximum value, and makes the target frame the new sound pressure estimation candidate point.

The input voice signal is input to the voice processing apparatus, the input voice signal being obtained through a gain adjustment by an amplification section and conversion from an analogue signal to a digital signal. The gain calculation section calculates the gain used for the gain adjustment in the gain application section and the gain used for the gain adjustment in the amplification section, based on the calculated gain.

According to an embodiment of the present disclosure, there is provided a program for causing a computer to execute the processes of extracting a feature quantity from a target frame of an input voice signal, making each of a plurality of frames of the input voice signal a sound pressure estimation candidate point, retaining the feature quantity of each sound pressure estimation candidate point, and updating the sound pressure estimation candidate point based on the feature quantity of the sound pressure estimation candidate point and the feature quantity of the target frame, calculating an estimated sound pressure of the input voice signal, based on the feature quantity of the sound pressure estimation candidate point, calculating a gain applied to the input voice signal based on the estimated sound pressure, and performing a gain adjustment of the input voice signal based on the gain.

According to an embodiment of the present disclosure, a feature quantity is extracted from a target frame of an input voice signal. Each of a plurality of frames of the input voice signal is made a sound pressure estimation candidate point, the feature quantity of each sound pressure estimation candidate point is retained, and the sound pressure estimation candidate point is updated based on the feature quantity of the sound pressure estimation candidate point and the feature quantity of the target frame. An estimated sound pressure of the input voice signal is calculated, based on the feature quantity of the sound pressure estimation candidate point. A gain applied to the input voice signal is calculated based on the estimated sound pressure. A gain adjustment of the input voice signal is performed based on the gain.

According to the embodiments of the present disclosure, a voice of an appropriate level can be more easily obtained.

### BRIEF DESCRIPTION OF THE DRAWINGS

FIG. 1 is a figure which describes a recording sensitivity setting;

FIG. 2 is a figure which shows a configuration of an input system of a recording device from related art;

FIG. 3 is a figure for describing the operation of an ALC processing section;

FIG. 4 is a figure which shows an example configuration of a voice processing system applicable to the present disclosure;

FIG. 5 is a flow chart which describes a gain adjustment process;

FIG. 6 is a flow chart which describes a sound pressure estimation candidate point updating process;

FIG. 7 is a figure which shows an example of updating sound pressure estimation candidate points and calculating an estimated sound pressure;

FIG. 8 is a figure which shows an example of updating sound pressure estimation candidate points and calculating an estimated sound pressure;

FIG. 9 is a figure for describing the influence on the estimated sound pressure by a sudden noise;

FIG. 10 is a figure which shows an example of updating sound pressure estimation candidate points and calculating an estimated sound pressure, in the case where a sudden noise is included;

FIG. 11 is a figure which shows an example configuration of a computer;

FIG. 12 is a figure which shows an example of a sound pressure level histogram based on the present disclosure;

FIG. 13 is a figure which shows an example of a sound pressure level histogram based on the present disclosure;

FIG. 14 is a figure which shows an example of values of sudden noise information and a sound pressure level; and

FIG. 15 is a figure which shows an example of a weighting for the sudden noise information.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments applicable to the present disclosure will be described with reference to the figures.

### The First Embodiment

### [Example Configuration Of A Voice Processing System]

Next, a specific embodiment applicable to the present disclosure will be described.

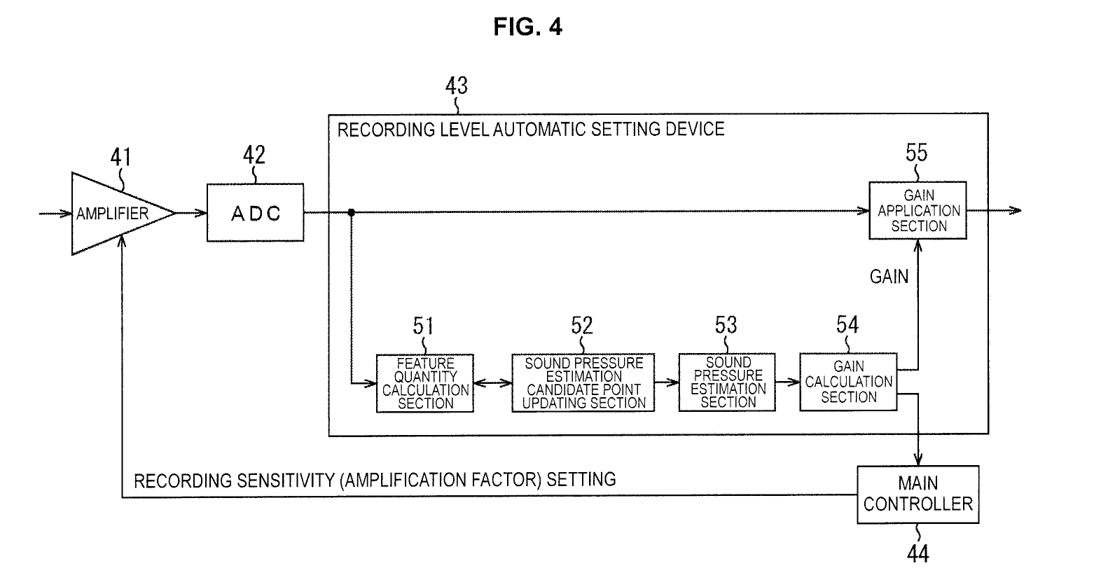

FIG. 4 is a figure which shows an example configuration of an embodiment of a voice processing system applicable to the present disclosure.

This voice processing system is arranged in a recording device such as an IC recorder, for example, and includes an amplifier 41, an ADC 42, a recording level automatic setting device 43, and a main controller 44.

A signal of a voice collected, for example, by a collected voice section such as a microphone (hereinafter, called an input voice signal) is input to the amplifier 41. The amplifier 41 amplifies the input voice signal by a recording sensitivity, that is, an amplification factor, designated from the main controller 44, and supplies the amplified input voice signal to the ADC 42.

The ADC 42 converts the input voice signal, supplied from the amplifier 41, from an analogue signal to a digital signal, and supplies the digital signal to the recording level automatic setting device 43. Note that the amplifier 41 and the ADC 42 may be assumed to be a single module. That is, the single module may include the functions of both the amplifier 41 and the ADC 42.

The recording level automatic setting device 43 generates and outputs an output voice signal by performing a gain adjustment for the input voice signal supplied from the ADC 42. The recording level automatic setting device 43 includes a feature quantity calculation section 51, a sound pressure estimation candidate point updating section 52, a sound pressure estimation section 53, a gain calculation section 54, and a gain application section 55.

The feature quantity calculation section 51 extracts one or more feature quantities from the input voice signal supplied from the ADC 42, and supplies the extracted feature quantities to the sound pressure estimation candidate point updating section 52. The sound pressure estimation candidate point updating section 52 updates sound pressure estimation candidate points used to estimate the sound pressure of the input voice signal, based on the feature quantities supplied from the feature quantity calculation section 51 and the feature quantities in the plurality of sound pressure estimation candidate points, and supplies information relating to the sound pressure estimation candidate points to the sound pressure estimation section 53.

The sound pressure estimation section 53 estimates the sound pressure of the input voice signal, based on the information relating to the sound pressure estimation candidate points supplied from the sound pressure estimation candidate point updating section 52, and supplies the estimated sound pressure obtained as a result of this to the gain calculation section 54.

The gain calculation section 54 calculates a target gain which shows the quantity to amplify the input voice signal, by comparing the estimated sound pressure supplied from the sound pressure estimation section 53 with the sound pressure which is a target of the input voice signal (hereinafter, called the target sound pressure). Further, the gain calculation section 54 divides the calculated target gain into an amplification factor in the amplifier 41 and a gain applied by the gain application section 55 (hereinafter, called the application gain), and supplies the amplification factor and the application gain to the main controller 44 and the gain application section 55.

The gain application section 55 performs gain adjustment of the input voice signal by applying the gain supplied from the gain calculation section 54 to the input voice signal supplied from the ADC 42, and outputs an output voice signal obtained as a result of this. The output voice signal output from the gain application section 55 is appropriately encoded and recorded to a recording medium, and is transmitted to another apparatus through a communication network such as a network.

Further, the main controller 44 supplies the amplification factor supplied from the gain calculation section 54 to the amplifier 41, and amplifies the input voice signal by the supplied amplification factor.

### [Description of the Gain Adjustment Process]

Incidentally, when the recording of a voice is designated for the voice processing system, the voice processing system adjusts the gain of the input voice signal so that the input voice signal, which has been input to the amplifier 41 by voice collection, becomes a signal of an appropriate level, and makes this signal an output voice signal.

In this case, the amplifier 41 amplifies the supplied input voice signal by the amplification factor supplied from the gain calculation section 54 through the main controller 44, and supplies the amplified input voice signal to the ADC 42. Further, the ADC 42 digitizes the input voice signal supplied from the amplifier 41, and supplies the digitized input voice signal to the feature quantity calculation section 51 and the gain application section 55 of the recording level automatic setting device 43.

In addition, the recording level automatic setting device 43 converts the input voice signal supplied from the ADC 42 to an output voice signal, by performing a gain adjustment process, and outputs the output voice signal.

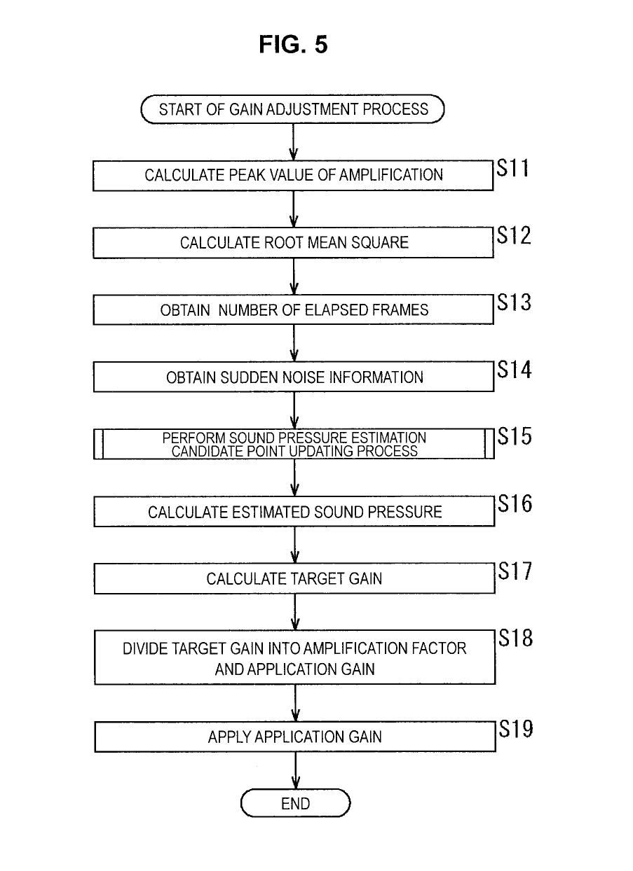

Hereinafter, the gain adjustment process by the recording level automatic setting device 43 will be described with reference to the flow chart of FIG. 5. Note that this gain adjustment process is performed for each frame of the input voice signal.

In step S11, the feature quantity calculation section 51 calculates a peak value of amplification Pk(n) in the time frame which is a processing target of the input voice signal (hereinafter, called the current frame), based on the input voice signal supplied from the ADC 42.

For example, when the current frame is the nth frame of the input voice signal (provided that n≧0), and each frame is assumed to constitute L samples, the feature quantity calculation section 51 calculates the peak value Pk(n) by calculating the following Equation (1).

$$Pk ( n ) = {max}_{0 \leq i \leq L - 1} \vert sig ( L \cdot n + i ) \vert \qquad ( 1 )$$

Note that in Equation (1), sig(L×n+i) is a sample value (value of the input voice signal) of the (L×n+i)th sample, by counting from the first sample of the 0th frame, from among the samples constituting the input voice signal. Therefore, the maximum value of the absolute values of the sample values from the sample constituting the current frame of the input voice signal is obtained as the peak value Pk(n).

In step S 12, the feature quantity calculation section 51 calculates a root mean square rms(n) of the sample values of each sample in the vicinity of the sample having the maximum amplitude in the current frame, based on the input voice signal supplied from the ADC 42.

For example, the feature quantity calculation section 51 calculates the root mean square rms(n) by making the sample which has the peak value Pk(n) in the current frame (frame n), that is, the sample which has the maximum amplitude, a sample i_max(n), and by calculating the following Equation (2).

$$rms ( n ) = \sqrt{\frac{1}{2 \cdot L} {\sum }_{i = i \_ m ax ( n ) - L 1}^{i \_ ma x ( n ) + L 2 - 1} {sig ( i )}^{2}} , 2 \cdot L = L 1 + L 2 \qquad ( 2 )$$

In Equation (2), i_max(n) represents the position of sample i_max(n), that is, what numerical position sample i_max(n) is in. Therefore, the root mean square rms(n) is the root mean square of the sample values of each sample in the section constituting a total of 2L samples, which includes an L1 sample in a past side of the sample i_max(n), and an L2-1 sample in a future side of the sample i_max.

Note that in Equation (2), while the range of the input voice signal which is the calculation target of the root mean square rms(n) is determined by the position of the sample i_max(n), the range of the input voice signal which is the calculation target may not be dependent on the position of the sample i_max(n).

For such a case, the feature quantity calculation section 51 calculates the root mean square rms(n) by calculating the following Equation (3).

$$rms ( n ) = \sqrt{\frac{1}{L} {\sum }_{i = 0}^{L - 1} {sig ( L \cdot n + i )}^{2}} \qquad ( 3 )$$

In the calculation of Equation (3), the root mean square of the sample values of each sample constituting the current frame is calculated as the root mean square rms(n). In this way, the calculation method of the root mean square rms(n), which uses samples in the range of the input voice signal not dependent on the position of the sample i_max(n), is especially effective in cases such as where there is a limit in the quantity of a buffer of the input voice signal.

In step S13, the feature quantity calculation section 51 calculates a frame number, for each sound pressure estimation candidate point at the present time retained in the sound pressure estimation candidate point updating section 52, from the frames made to be these sound pressure estimation candidate points up to the current frame, as the number of elapsed frames. In this case, the feature quantity calculation section 51 refers to the information relating to the sound pressure estimation candidate points retained in the sound pressure estimation candidate point updating section 52 as necessary, and obtains the number of elapsed frames.

In step S14, the feature quantity calculation section 51 calculates sudden noise information Atk(n), which shows the likeliness of a sudden noise in the current frame, based on the input voice signal supplied from the ADC 42. Here, for example, a sudden noise such as a keystroke sound of a keyboard or a sound generated when an object drops to the floor, which differs from the original voice to be collected, is a noise which is suddenly generated.

For example, the feature quantity calculation section 51 calculates sudden noise information Atk(n) by calculating the following Equation (4).

$$Atk ( n ) = \frac{{max}_{n - N 1 \leq m \leq n + N 2} Pk ( m )}{{min}_{n - N 1 \leq m \leq n + N 2} Pk ( m )} \qquad ( 4 )$$

That is, in the calculation of Equation (4), first a section of the total (N1+N2+1) frames, which includes frame n which is the current frame, a past frame N1 as seen from frame n, and a future frame N2 as seen from frame n, is made a section to be processed. Then, a ratio of the minimum to maximum values from among the peak values Pk(m) of each frame in the section to be processed, that is, a value obtained by dividing the maximum value of the peak values Pk(m) by the minimum value of the peak values Pk(m), is made the sudden noise information Atk(n).

Note that if the sudden noise information Atk(n) is information which can detect a sharp change in the input voice information, it is not limited to the example shown in Equation (4), and may be of any type. For example, the feature quantity calculation section 51 may calculate sudden noise information Atk(n) by calculating the following Equation (5).

$$Atk ( n ) = {max}_{n - N 1 \leq m \leq n + N 2 - 1} \frac{Pk ( m + 1 )}{Pk ( m )} \qquad ( 5 )$$

In Equation (5), a ratio of the peak values Pk(m) of two consecutive frames in a section to be processed is obtained, for a section to be processed of the total (N1+N2+1) frames, which includes frame n, past frame N1 of frame n, and future frame N2 of frame n. That is, the peak value Pk(m+1) obtained for the frame (m+1) is divided by the peak value Pk(m) obtained for the frame m. Then, the maximum value from among the ratios of the peak values Pk(m), which have been obtained for each group of two continuous frames in the section to be processed, is made the sudden noise information Atk(n).

Further, the peak value Pk(m) used when obtaining the sudden noise information Atk(n) may be obtained after decreasing fluctuations in the vicinity of a direct current component of the input voice signal, by filter processing the input voice signal by a low cut filter.

As described above, when the peak value Pk(n), the root mean square rms(n), the number of elapsed frames, and the sudden noise information Atk(n) are obtained, the feature quantity calculation section 51 makes a set of feature quantities, which are these four values extracted from the input voice signal of the current frame, and supplies these feature quantities to the sound pressure estimation candidate point updating section 52.

In step S15, the sound pressure estimation candidate point updating section 52 updates the sound pressure estimation candidate points by performing a sound pressure estimation candidate point updating process, and supplies the root mean square rms(n) of each sound pressure estimation candidate point after updating to the sound pressure estimation section 53.

Note that while the details of the sound pressure estimation candidate point updating process will be described later, the updating of the sound pressure estimation candidate points is performed in this sound pressure estimation candidate point updating process based on the feature quantities of the current frame, and the feature quantities in P sound pressure estimation candidate points retained in the sound pressure estimation candidate point updating section 52.

Specifically, in the case where there is a candidate point, which has become inappropriate as a sound pressure estimation candidate point, in the P sound pressure candidate points at the present time, this sound pressure estimation candidate point is excluded, and the current frame is made a new sound pressure estimation candidate point. Therefore, the P sound pressure estimation candidate points and the feature quantities of these sound pressure estimation candidate points are normally retained in the sound pressure estimation candidate point updating section 52.

Note that hereinafter, a frame which is made a sound pressure estimation candidate point will appropriately be called frame nₚ (provided that 1≦p≦P).

In step S16, the sound pressure estimation section 53 calculates an estimated sound pressure of the input voice signal, based on the root mean squares of the P sound pressure candidate points rms(nₚ) supplied from the sound pressure estimation candidate point updating section 52, and supplies the estimated sound pressure to the gain calculation section 54.

For example, the sound pressure estimation section 53 calculates the estimated sound pressure est_rms(n) by calculating the following Equation (6).

$$est\_rms ( n ) = \sqrt{\frac{1}{P} {\sum }_{p = 1}^{P} {rms ( {n}_{p} )}^{2}} \qquad ( 6 )$$

That is, in Equation (6), the estimated sound pressure est_rms(n) is calculated by obtaining the root mean square of the P root mean squares rms(nₚ) obtained for frame n₁, which has been made a sound pressure estimation candidate point, through to frame nₚ.

Note that the estimated sound pressure est_rms(n) is not limited to the calculation of Equation (6), and if it is calculated by using the feature quantities of each sound pressure estimation candidate point, it may be calculated in any way. For example, the sound pressure estimation section 53 may calculate the estimated sound pressure est_rms(n) by calculating the following Equation (7).

$$est\_rms ( n ) = \sqrt{\frac{1}{W\_all} {\sum }_{p = 1}^{P} w ( {n}_{p} ) \cdot {rms ( {n}_{p} )}^{2 }} \qquad ( 7 )$$

In Equation (7), the estimated sound pressure est_rms(n) is calculated for the P root mean squares rms(nₚ), by applying a weighting w(nₚ) different for each sound pressure estimation candidate point, and obtaining a weighting average.

Note that in Equation (7), the weighting w(nₚ) is a function which decreases in accordance with the number of elapsed frames from frame nₚ up to the current frame, and W_all is a value obtained by the following Equation (8). That is, W_all is the sum total of the weighting w(nₚ) of each frame nₚ.

$$W\_all = {\sum }_{p = 1}^{P} w ( {n}_{p} ) \qquad ( 8 )$$

In step S17, the gain calculation section 54 calculates a target gain of the current frame, by comparing the estimated sound pressure est_rms(n) supplied from the sound pressure estimation section 53 with a predetermined target sound pressure.

For example, the gain calculation section 54 calculates a target gain tgt_gain(n), by calculating the following Equation (9) and obtaining the difference between a target sound pressure tgt_rms and the estimated sound pressure est_rms(n).

tgt_gain(n)=tgt_rms−est_rms(n) (9)

In step S18, the gain calculation section 54 divides the target gain tgt_gain(n) into an amplification factor in the amplifier 41 and an application gain applied by the gain application section 55.

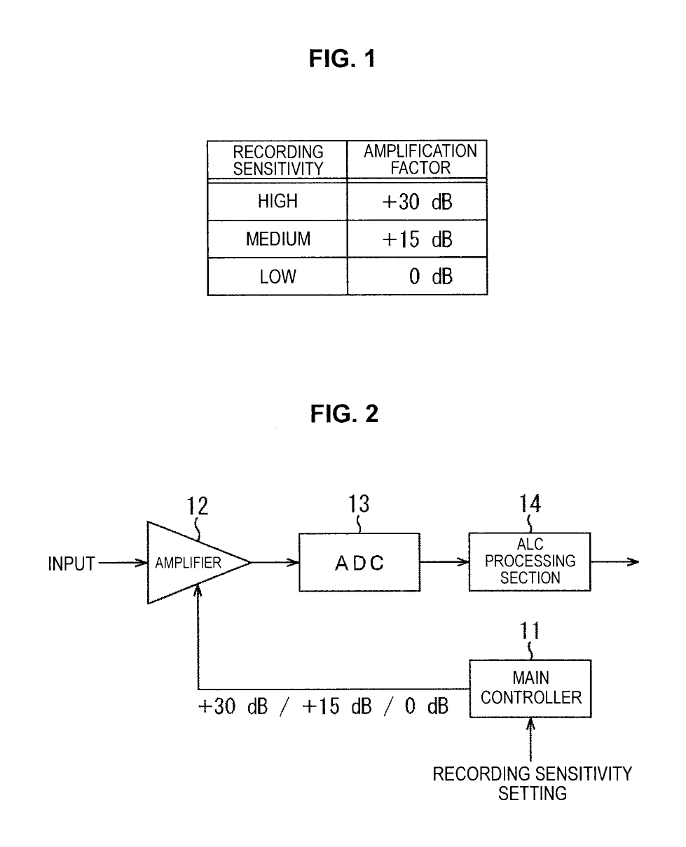

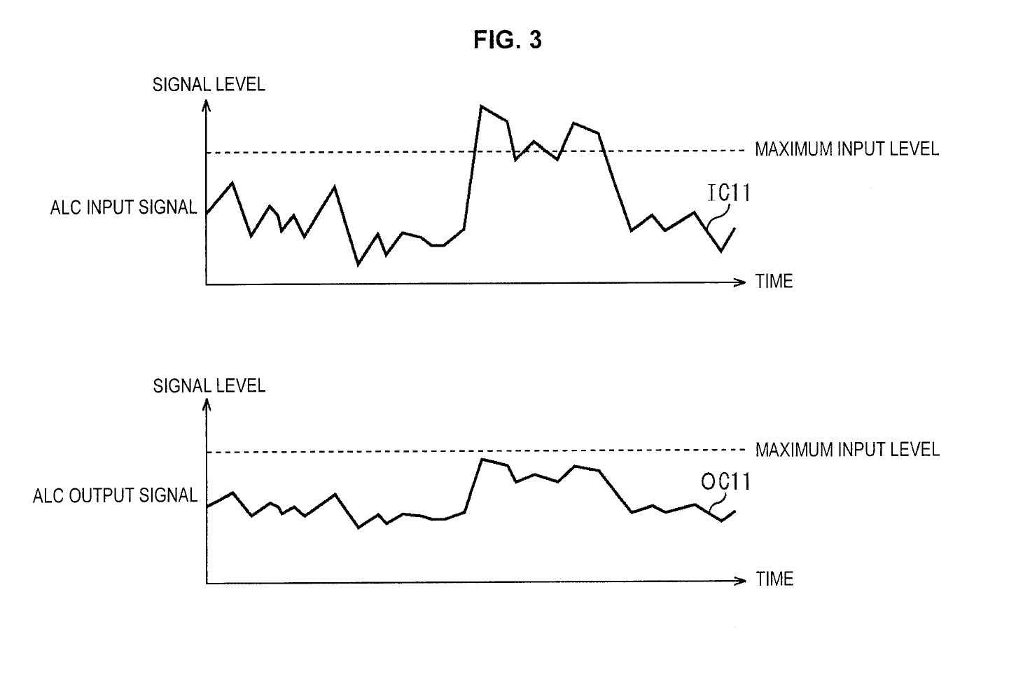

For example, in the amplifier 41, the amplification factor can be controlled by the three stages of high, medium, and low, as shown in FIG. 1. That is, the amplification factor of the amplifier 41 can increase and decrease in 15 dB units from 0 dB to +30 dB.

Now, the amplification factor set in the amplifier 41 is 0 dB, and the target gain tgt_gain(n) is 18 dB. For such a case, the gain calculation section 54 divides the 18 dB, which is the target gain tgt_gain(n), into +15 dB as the amplification factor of the amplifier 41, and 3 dB as the application gain.

Here, the reason for the amplification factor being made +15 dB is that when the amplification factor in the amplifier 41 increases and decreases within the range capable of being set, the maximum of the values which do not exceed 18 dB, which is the target gain, is 15 dB from among the values obtained as the amplification factor of the increasing and decreasing part. Accordingly, the gain calculation section 54 allocates 15 dB from within the target gain to the amplification factor of the amplifier 41, and allocates the remaining 3 dB to the application gain of the gain application section 55.

When the gain calculation section 54 divides the target gain into an application factor and an application gain in this way, the amplification factor is supplied to the main controller 44, and the application gain is supplied to the gain application section 55.

The main controller 44 supplies the amplification factor supplied from the gain calculation section 54 to the amplifier 41, and changes the amplification factor of the amplifier 41. In this case, the main controller 44 performs control of the change of the amplification factor, such as by synchronizing the change of the amplification factor of the amplifier 41 with the application of the gain to the input voice signal of the gain application section 55. When the amplification factor of the amplifier 41 is changed in this way, the amplifier 41 amplifies the supplied input voice signal by the amplification factor after the change. That is, a gain adjustment (amplification) is performed for the input voice signal by the changed gain (amplification factor).

Note that the actual target gain may be calculated by using a time constant of an attack time and a release time, so that the gain does not rapidly change. The process which calculates the gain by using the time constant of an attack time and a release time is generally used in ALC (Automatic Level Control) technology.

In step S19, the gain application section 55 performs a gain adjustment of the input voice signal, by applying the application gain supplied from the gain calculation section 54 to the input voice signal supplied from the ADC 42, and outputs an output voice signal obtained as a result of this.

Here, the input voice signal supplied to the gain application section 55 is sig(L×n+i), and when the application gain supplied from the gain calculation section 54 to the gain application section 55 is sig_gain(n,i), the gain application section 55 generates an output voice signal by calculating the following Equation (10).

out_sig(L·n+i)=sig_gain(n,i)·sig(L·n+i) (10)

That is, the gain application section 55 makes the output voice signal out_sig(L×n+i) by multiplying the application gain sig_gain(n,i) by the input voice signal sig(L×n+i). In more detail, the application gain sig_gain(n,i) for the (L×n+i)th sample of the input voice signal is multiplied by the sample value (L×n+i) of the (L×n+i)th sample of the input voice signal, and is made the sample value of the (L×n+i)th sample of the output voice signal out_sig (L×n+i).

Note that, in the case where the gain is simply applied to the input voice signal, there are cases where an output voice signal out_sig(i) is clipped by saturating at 0 dBFS. Accordingly, a process for preventing such clipping may be performed during the gain application. For example, a process which is generally performed with an ALC, a compressor, or the like may be used as a process which prevents clipping.

When gain adjustment is performed for the input voice signal, and the output voice signal is generated, the generated output voice signal is output from the gain application section 55, and the gain adjustment process ends.

As described above, the recording level automatic setting device 43 updates the sound pressure estimation candidate points by calculating the feature quantities from the supplied input voice signal, and calculates the estimated sound pressure from the feature quantities of each sound pressure estimation candidate point. Then, the recording level automatic setting device 43 obtains the target gain from the estimated sound pressure, adjusts the gain of the input voice signal based on the target gain, and makes an output voice signal.

In this way, appropriate sound pressure estimation candidate points are selected for the estimation of the sound pressure, based on the feature quantities, and a target gain with a higher accuracy can be obtained by a more simple process, by obtaining the estimated sound pressure. In this way, an output voice signal of an appropriate level can be obtained.

According to an embodiment of the present disclosure, since not only the application gain, but also an appropriate amplification factor in the amplifier 41, is calculated by a simple process in the recording level automatic setting device 43, the setting of a recording sensitivity can be automated by a sufficiently feasible method, even for a compact recording device. That is, with respect to a user, a voice of an appropriate level is recorded by just pushing a recording button.

### [Description of the Sound Pressure Estimation Candidate Point Updating Process]

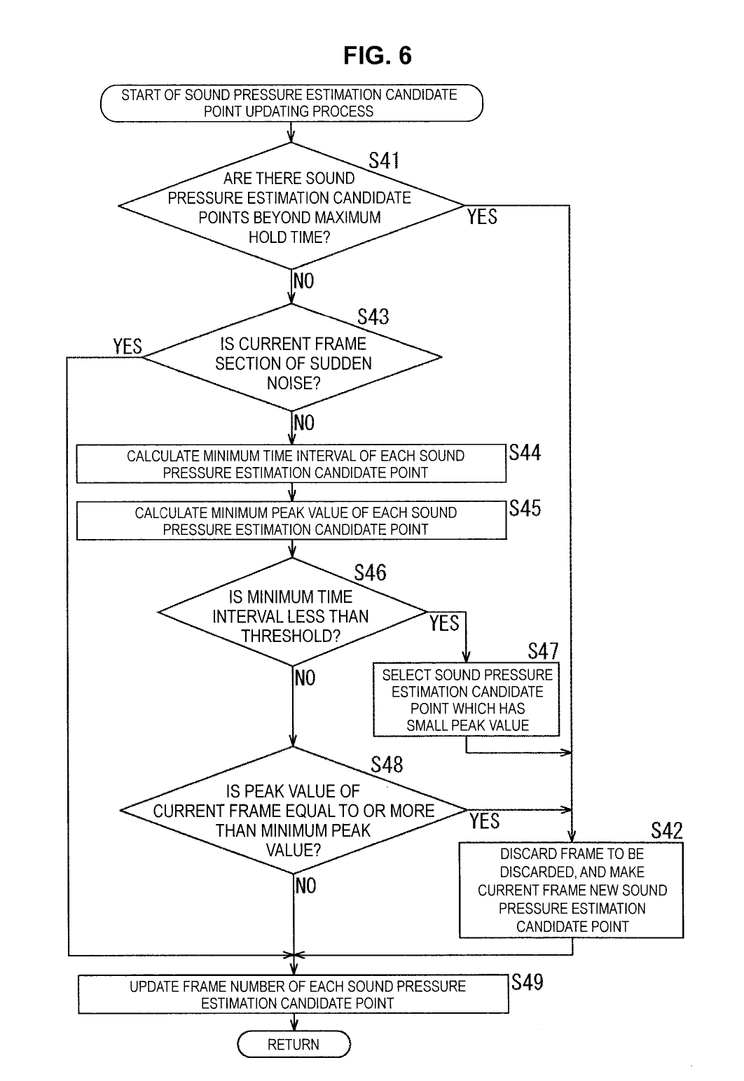

Next, the sound pressure estimation candidate point updating process corresponding to the process of step S15 of FIG. 5 will be described with reference to the flow chart of FIG. 6.

At the time when this sound pressure estimation candidate point updating process begins, the peak value Pk(n), root mean square rms(n), number of elapsed frames, and sudden noise information Atk(n) are supplied from the feature quantity calculation section 51 to the sound pressure estimation candidate point updating section 52 as a set of feature quantities of the current frame.

Further, a set of feature quantities of each P sound pressure estimation candidate point, previously supplied from the feature quantity calculation section 51, is retained in the sound pressure estimation candidate point updating section 52. In addition, when a recording operation begins, an appropriate initial value is set as the P sound pressure estimation candidate points and the feature quantities of these sound pressure estimation candidate points.

In step S41, the sound pressure estimation candidate point updating section 52 judges whether or not there are sound pressure estimation candidate points retained beyond a predetermined maximum hold time, based on the number of elapsed frames as a feature quantity of the current frame supplied from the feature quantity calculation section 51.

For example, the sound pressure estimation candidate point updating section 52 specifies a maximum value from among the number of elapsed frames of each of the P frames nₚ (provided that 1≦p≦P), which are made sound pressure estimation candidate points at the present time, that is, the number of elapsed frames which satisfies the following Equation (11).

$$n\_max = {max}_{1 \leq p \leq P} {n}_{p} \qquad ( 11 )$$

Note that in Equation (11), nₚ shows the number of elapsed frames of the frame nₚ, and the maximum from among the P elapsed frames nₚ is made the maximum number of elapsed frames n_max.

The sound pressure estimation candidate point updating section 52 judges whether or not the obtained maximum number of elapsed frames n_max is larger than a predetermined threshold th_max, and in the case where the maximum number of elapsed frames n_max is larger than the threshold th_max, it is assumed that there are sound pressure estimation candidate points retained beyond the maximum hold time. Here, the threshold th_max is a value (frame number) which shows the maximum hold time.

In step S41, in the case where it is judged that there are sound pressure estimation candidate points retained beyond the maximum hold time, the sound pressure estimation candidate point updating section 52 selects the frame nₚ, which has been made the maximum number of elapsed frames n_max, as a frame to be discarded, and the process proceeds to step S42.

When a previous frame, which is separated far from the current frame, is used as the sound pressure estimation candidate point for calculating the estimated sound pressure in the current frame, it is possible that a correct estimated pressure may not be able to be obtained. Accordingly, in the case where there are sound pressure estimation candidate points retained beyond the maximum hold time, the longest retained one from among the sound pressure estimation candidate points is made a frame to be discarded. That is, the sound pressure estimation candidate point is made an inappropriate frame.

In step S42, the sound pressure estimation candidate point updating section 52 discards the frame selected as the frame to be discarded and the feature quantities of this frame, and the current frame is made a new sound pressure estimation candidate point.

That is, the sound pressure estimation candidate point updating section 52 excludes the frame to be discarded from the sound pressure estimation candidate points, and retains information specifying the current frame, the feature quantities of the current frame, and the new sound pressure estimation candidate point, as a set of feature quantities of these sound pressure estimation candidate points.

When the process of step S42 is performed, the process thereafter proceeds to step S49.

Further in step S41, in the case where it is judged that there are no sound pressure estimation candidate points retained beyond the maximum hold time, that is, in the case where the maximum number of elapsed frames n_max is equal to or less than the threshold th_max, the process proceeds to step S43.

In step S43, the sound pressure estimation candidate point updating section 52 judges whether or not the current frame is a section of a sudden noise.

For example, in the case where sudden noise information Atk(n), which is supplied from the feature quantity calculation section 51 as a feature quantity of the current frame, is larger than a predetermined threshold th_atk, the sound pressure estimation candidate point updating section 52 judges that the current frame is a section of a sudden noise.

In the case where the current frame is judged to be a section of a sudden noise in step S43, updating of the sound pressure estimation candidate points is not performed, and the process proceeds to step S49.

For example, in the case where a frame which includes a sudden noise is selected as a sound pressure estimation candidate point, if the estimated sound pressure is obtained by using this frame, there will be cases where the sound pressure of the original voice to be collected is not be able to be correctly obtained as the estimated sound pressure. Accordingly, in the case where the current frame is a frame which includes a sudden noise, this frame is made an inappropriate frame for the calculation of the estimated sound pressure, and the sound pressure estimation candidate point updating section 52 excludes this frame from the sound pressure estimation candidate points.

On the other hand, in the case where the current frame is judged not to be a section of a sudden noise in step S43, that is, in the case where the sudden noise information Atk(n) is equal to or less than the threshold th_atk, the process proceeds to step S44.

Note that, in the judgment of whether or not the current frame is a section of a sudden noise, the judgment may be performed not only by simply comparing the sudden noise information Atk(n) with the threshold th_atk, but also by taking into consideration the feature quantities of the P sound pressure estimation candidate points.

For example, when a mean value of the root mean squares of the P sound pressure estimation candidate points rms(nₚ) is low, the threshold th_atk may be set to be lower, and conversely when a mean value of the root mean squares rms(nₚ) is high, the threshold th_atk may be set to be higher. In this way, sudden noise can be detected by an appropriate sensitivity, in accordance with the sound pressure of the previous frames of the input voice signal. That is, the sensitivity of sudden noise detection can be appropriately changed.

In step S44, the sound pressure estimation candidate point updating section 52 calculates a minimum time interval, which is a minimum value of the time intervals among the sound pressure estimation candidate points adjacent in the direction of time, based on the number of elapsed frames nₚ supplied from the feature quantity calculation section 51 as a feature quantity.

Specifically, the sound pressure estimation candidate point updating section 52 calculates the minimum time interval ndiff_min by calculating the following Equation (12).

$$ndiff\_min = {min}_{2 \leq p \leq P} \vert {n}_{p} - {n}_{p - 1} \vert \qquad ( 12 )$$

That is, in Equation (12), a differential absolute value between the number of elapsed frames nₚ₋₎₁ of a frame nₚ−1, and the number of elapsed frames nₚ of an adjacent frame nₚ (provided that 2≦p≦P), is obtained for each value ofₚ, and the minimum value of these differential absolute values is made the minimum time interval ndiff_min.

In step S45, the sound pressure estimation candidate point updating section 52 calculates a minimum peak value Pk_min by calculating the following Equation (13), based on the peak values in each of the retained sound pressure estimation candidate points Pk(nₚ).

$$Pk\_min = {min}_{1 \leq p \leq P} Pk ( {n}_{p} ) \qquad ( 13 )$$

In Equation (13), the minimum from among the peak values in each of the P sound pressure estimation candidate points Pk(nₚ) (provided that 1≧p≧P) is made the minimum peak value Pk_min.

In step S46, the sound pressure estimation candidate point updating section 52 judges whether or not the minimum time interval ndiff_min obtained in step S44 is less than a predetermined threshold th_ndiff.

In step S46, in the case where it is judged that the minimum time interval ndiff_min is less than the threshold th_ndiff, the process proceeds to step S47.

In step S47, the sound pressure estimation candidate point updating section 52 selects the sound pressure estimation candidate point, which has the smallest peak value Pk(nₚ) from among the sound pressure estimation candidate points used for obtaining the minimum time interval ndiff_min, as a frame to be discarded. That is, the frame which has the smallest peak value between two sound pressure estimation candidate points, arranged in the minimum time interval ndiff_min, is made a frame to be discarded.

In this way, it is possible to prevent sound pressure estimation candidate points concentrating at a specific time slot with a high sound pressure, by making one of the sound pressure estimation candidate points arranged in a short time interval a frame to be discarded, and excluding this frame from the sound pressure estimation candidate points. In this way, a more appropriate estimated sound pressure can be obtained.

In particular, if a sound pressure estimation candidate point, which has the smallest peak value Pk(nₚ) from among the sound pressure estimation candidate points arranged in the minimum time interval ndiff_min, is selected as a frame to be discarded, the frame with the largest peak value is used for the sound pressure estimation. In this way, clipping of the recorded voice can be controlled.

Note that the threshold th_ndiff, as compared to the minimum time interval ndiff_min, may increase with the passage of the processing time. In such a case, a more appropriate estimated sound pressure can be obtained, by increasing the time interval between adjacent sound pressure estimation candidate points with time, and by distributing the sound pressure estimation candidate points.

When a frame to be discarded is selected in this way, the process thereafter proceeds from step S47 to step S42, the selected frame to be discarded is discarded, and the current frame is made a new sound pressure estimation candidate point.

Further, in the case where it is judged in step S46 that the minimum time interval ndiff_min is equal to or more than the threshold th_ndiff, in step S48, the sound pressure estimation candidate point updating section 52 judges whether or not the peak value of the current frame Pk(n) is equal to or more than the minimum peak value Pk_min.

In step S48, in the case where it is judged that the peak value of the current frame Pk(n) is equal to or more than the minimum peak value Pk_min, the sound pressure estimation candidate point updating section 52 selects a sound pressure estimation candidate point which has the minimum peak value Pk_min as a frame to be discarded, and the process proceeds to step S42.

In the recording level automatic setting device 43, the frame with a peak value as large as possible is made a sound pressure estimation candidate point, so that the recorded voice is not clipped. Accordingly, in the case where the peak value of the current frame Pk(n) is equal to or more than the minimum peak value Pk_min, a sound pressure estimation candidate point which has the minimum peak value Pk_min is discarded, so that the current frame with a larger peak value is made a new sound pressure estimation candidate point.

When the frame to be discarded is selected in this way, in step S42, the selected frame to be discarded is discarded, and the current frame is made a new sound pressure estimation candidate point.

On the other hand, in step S48, in the case where it is judged that the peak value of the current frame Pk(n) is less than the minimum peak value Pk_min, the process proceeds to step S49. In this case, the current frame is not made a sound pressure estimation candidate point.

When it is judged that the peak value Pk(n) is less than the minimum peak value Pk_min in step S48, or the current frame is made a new sound pressure estimation candidate point in step S42, or it is judged that the current frame is a section of a sudden noise in step S43, the process of step S49 is performed.

That is, in step S49, the sound pressure estimation candidate point updating section 52 updates the frame number of each sound pressure estimation candidate point.

For example, the sound pressure estimation candidate point updating section 52 reapplies the frame number for identifying each sound pressure estimation candidate point, for each frame made a sound pressure estimation candidate point. Specifically, frames n₁ to nₚ in the order from the oldest time-wise are made for each of the frames which have been made a sound pressure estimation candidate point. That is, the sound pressure estimation candidate point which is the oldest time-wise is made frame n₁.

In this way, when the sound pressure estimation candidate point is appropriately updated, the sound pressure estimation candidate point updating section 52 supplies the root mean squares rms(nₚ), which have been retained as feature quantities of each sound pressure estimation candidate point, after updating to the sound pressure estimation section 53, and the sound pressure estimation candidate point updating process ends. When the sound pressure estimation candidate point updating process ends, the process thereafter proceeds to step S16 of FIG. 5.

As described above, the recording level automatic setting device 43 updates the sound pressure estimation candidate points, based on the feature quantities of the current frame, and the feature quantities of the retained P sound pressure estimation candidate points. In this way, a more appropriate estimated sound pressure can be obtained by appropriately updating the sound pressure estimation candidate points.

In the above described embodiment, while a method which retains the feature quantities of a frame with large peak values has been described as an updating process of the sound pressure estimation candidate points, other embodiments can also use a method which retains the feature quantities of a frame with a large root mean square rms(n), from the viewpoint of retaining the feature quantities of a frame with a large sound pressure level.

### [Regarding Gain Adjustment of the Input Voice Signal]

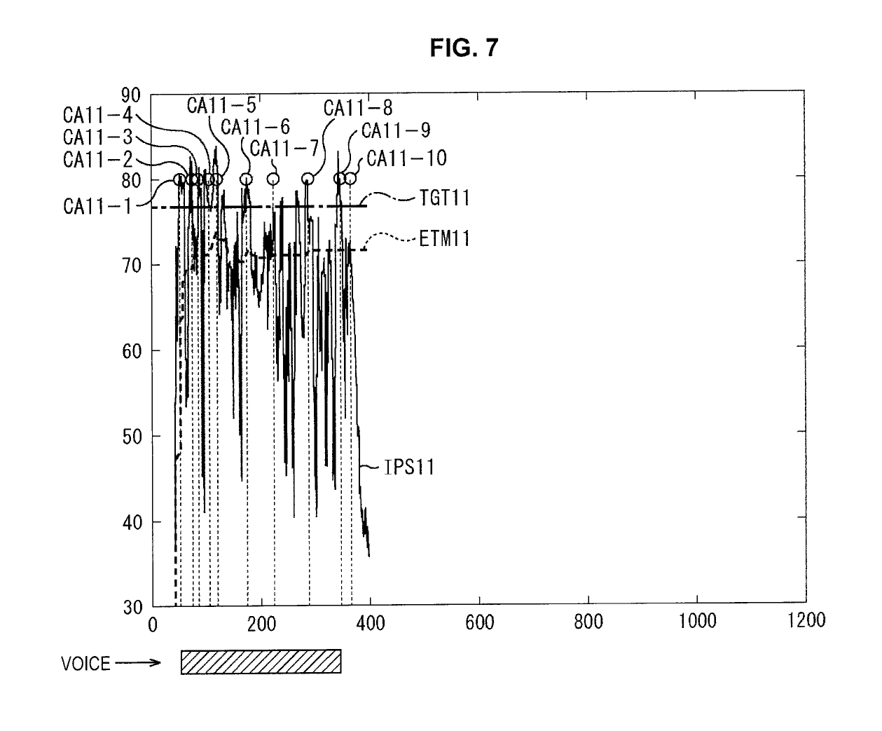

Next, a specific example of the gain adjustment of the input voice signal, which has been described above, will be described with reference to FIGS. 7 to 10.

Note that in FIGS. 7 to 10, the horizontal axis shows a time frame, that is, the frame number of the input voice signal, and the vertical axis shows an absolute sound pressure level (dB SPL (Sound Pressure Level)) of the input voice signal.

Further in FIGS. 7 to 10, the hatched rectangles under the horizontal axis show sections of the voice to be recorded, that is, sections in which there is no noise.

The relationship between the input voice signal, sound pressure estimation candidate point, and estimated sound pressure is shown in FIG. 7.

That is, the solid polygonal line IPS11 represents the maximum value of the absolute sound pressure level in each frame of the input voice signal input to the recording level automatic setting device 43, and each of the dotted straight lines CA11-1 to CA11-10, with a circle attached to an end, represents a sound pressure estimation candidate point. Further, the dotted polygonal line ETM11 represents the estimated sound pressure in each frame, and the dashed straight line TGT11 represents the target sound pressure.

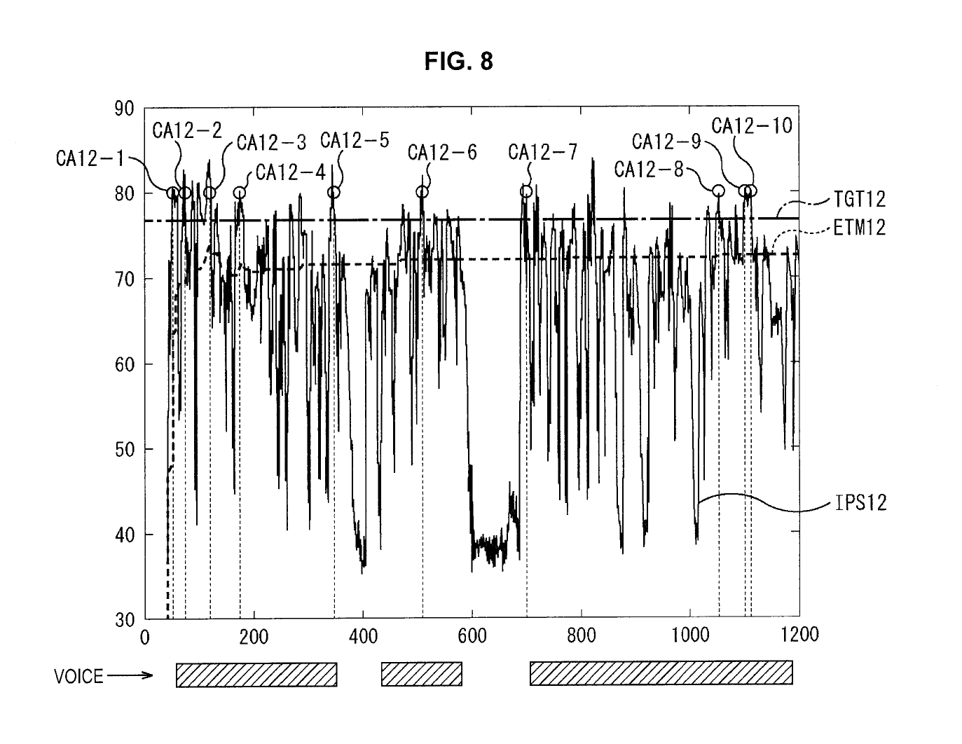

Note that, the position within the figures and the position in the vertical direction of the circles, which represent the straight lines CA11-1 to CA11-10, do not have any particular significance, and only the position in the horizontal direction, that is, the position on the time axis, has significance, and this may be assumed to be similar in FIGS. 8 to 10 described below. That is, the position of the circles, which are attached to the straight lines representing the sound pressure estimation candidate points, in the vertical direction does not have any particular significance. Hereinafter, in the case where it is not necessary to particularly distinguish the straight lines CA11-1 to CA11-10, they will simply be called straight lines CA11.

In the example of FIG. 7, the positions denoted by the straight lines CA11 are the positions of each sound pressure estimation candidate point when data for 400 frames is input as the input voice signal. Further, the polygonal line ETM11 shows the history of the estimated sound pressure of each frame, obtained up to 400 frames, by the sound pressure estimation candidate points changing every moment.

In this example, a difference between the target sound pressure denoted by the straight line TGT11 in each frame, and the estimated sound pressure denoted by the polygonal line ETM11, is made the target gain. Then, part of the target gain is made the applicable gain of the current frame, and the remaining part is made the amplification factor of the next frame in the amplifier 41.

Therefore, the input voice signal prior to being digitized is amplified by the amplification factor obtained by the previous frame, and the input voice signal after amplification is further digitized and input to the recording level automatic setting device 43. Then, in the recording level automatic setting device 43, the input voice signal of the input current frame is amplified by the amplification gain of the current frame, and the signal obtained as a result of this is output as an output voice signal.

Here, in order to plainly show the updating of the sound pressure estimation candidate points, a state is shown in FIG. 8 of when the process is performed up to 1200 frames, for an input voice signal denoted by the polygonal line IPS11.

Note that in FIG. 8, the solid polygonal line IPS 12 represents the maximum value of the absolute sound pressure level in each frame of the input voice signal input to the recording level automatic setting device 43, and each of the dotted straight lines CA12-1 to CA12-10, with a circle attached to an end, represents a sound pressure estimation candidate point. Further, the dotted polygonal line ETM12 represents the estimated sound pressure in each frame, and the dashed straight line TGT12 represents the target sound pressure.

Hereinafter, in the case where it is not necessary to particularly distinguish the straight lines CA12-1 to CA12-10, they will simply be called straight lines CA12.

The polygonal line IPS11, the polygonal line ETM11, and the straight line TGT11 shown in FIG. 7 represent a part of the polygonal line IPS12, the polygonal line ETM12, and the straight line TGT12 of FIG. 8, respectively, that is, the part up to the 400th frame.

As shown in FIG. 7, up to the time when the 400th frame of the input voice signal is input to the recording level automatic setting device 43, the sound pressure estimation candidate points denoted by each of the straight lines CA11 are concentrated in the section from the 0th frame up to the 400th frame.

When the frames of the input voice signal are input, sequentially from such a condition, the sound pressure estimation candidate points change from the condition shown in FIG. 7 to the condition shown in FIG. 8. That is, it becomes a condition in which the sound pressure estimation candidate points are interspersed in the intervals of levels within wide sections.

In this way, the sound pressure estimation candidate points are made by collecting a plurality of peak values of the amplitude of the input voice signal which are large, and a recording level can be set so that the output voice signal is recorded at an appropriate signal level while suppressing clipping or the like as much as possible, by performing at all times an update of the sound pressure estimation candidate points. However, in the case where an estimation of the sound pressure is performed by selectively using such frames with large peak values, there are cases where an appropriate estimated sound pressure may not be able to be obtained, due to the sudden occurrence of a large noise.

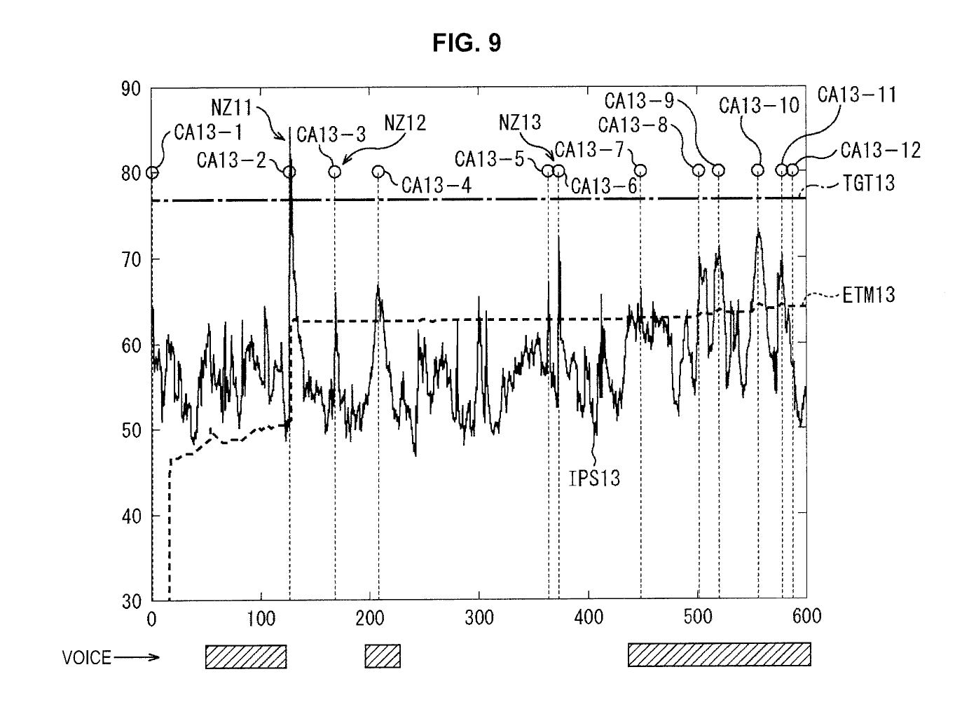

For example, as shown in FIG. 9, a sudden noise is included in the input voice signal.

Note that in FIG. 9, the solid polygonal line IPS13 represents the maximum value of the absolute sound pressure level in each frame of the input voice signal input to the recording level automatic setting device 43, and each of the dotted straight lines CA13-1 to CA13-12 represents a sound pressure estimation candidate point. Further, the dotted polygonal line ETM13 represents the estimated sound pressure in each frame, and the dashed straight line TGT13 represents the target sound pressure.

Hereinafter, in the case where it is not necessary to particularly distinguish the straight lines CA13-1 to CA13-12, they will simply be called straight lines CA13.

In FIG. 9, the parts shown by the arrows NZ11 and NZ12 are parts (frames) in which a sudden noise, which has occurred due to a falling object, is included, and the parts shown by the arrows NZ13 are parts in which a keystroke sound of a keyboard is included.

In this example, when each of the sound pressure estimation candidate points is determined, a process is performed so that sudden noise information is not used as a feature quantity. First, in order for the peak value as a feature quantity to increase in accordance with a noise due to a falling object, in a frame near the 125th frame denoted by the arrow NZ11, that is, a frame of the position shown by the straight line CA13-2, this frame is made a sound pressure estimation candidate point. As a result of this, the estimated sound pressure rapidly changes from approximately 50 dBSPL up to approximately 65 dBSPL, as denoted by the dotted polygonal line ETM13, in the frame of the position shown by the straight line CA13-2.

Similar to the position denoted by the arrow NZ11, the frames of the positions denoted by the arrows NZ12 and NZ13 are also made sound pressure estimation candidate points in accordance with a sudden noise, such as a noise due to a dropped object or a keystroke sound of a keyboard.

That is, the position denoted by the arrow NZ12 becomes the position shown by the straight line CA13-3, which has been made a sound pressure estimation candidate point, and the position denoted by the arrow NZ13 becomes the position shown by the straight line CA13-6, which has been made a sound pressure estimation candidate point.

In this way, when the frame of a sudden noise is made a sound pressure estimation candidate point, the estimated sound pressure increases, and an appropriate estimated sound pressure may not be able to be obtained.

Here, in order to avoid an adverse influence due to such a sudden noise, in the recording level automatic setting device 43, sudden noise information is obtained in the feature quantity calculation section 51, and updating of the sound pressure estimation candidate points is performed by using the sudden noise information in the sound pressure estimation candidate point updating section 52.

Specifically, based on the sudden noise information, it is judged whether or not the current frame is a section of a sudden noise, and in the case where the current frame is a section of a sudden noise, the sound pressure estimation candidate points are not updated in the current frame. That is, the current frame which is a section of a sudden noise is not made a sound pressure estimation candidate point. In this way, an appropriate estimated sound pressure of the input voice signal can be obtained.

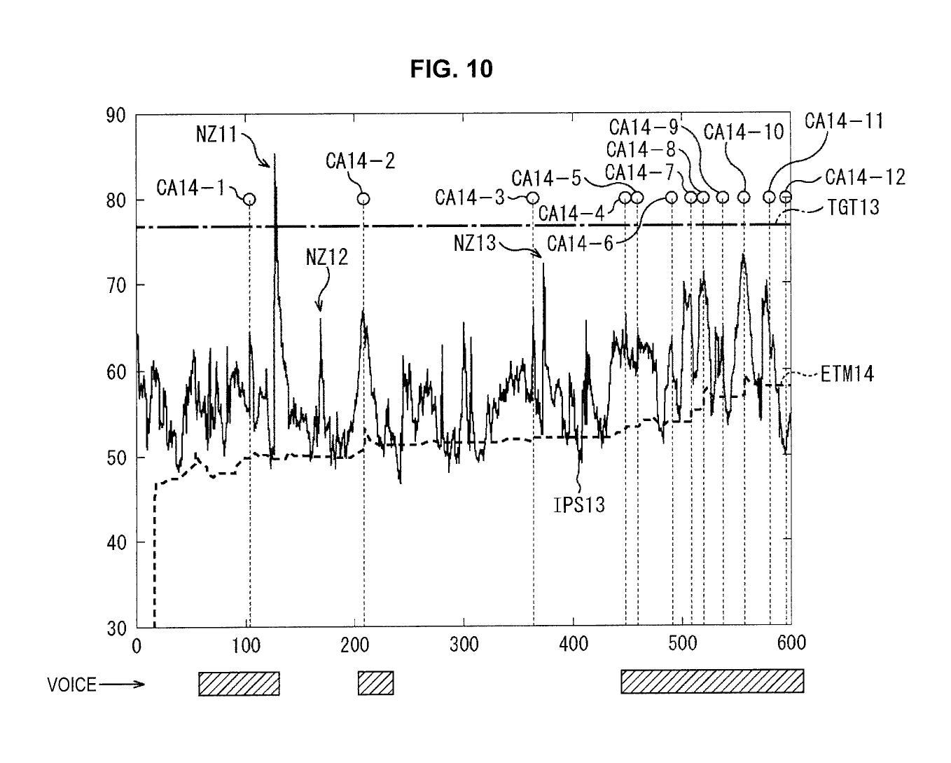

For example, as shown in FIG. 10, since a section of a sudden noise is excluded from the sound pressure estimation candidate points in the recording level automatic setting device 43, an appropriate estimated sound pressure can be obtained for the input voice signal, such as shown by the polygonal line ETM14.

Note that FIG. 10 shows each sound pressure estimation candidate point and estimated sound pressure when a signal similar to the input voice signal shown in FIG. 9 is input to the recording level automatic setting device 43, and since the same reference numerals in FIG. 10 denote parts corresponding to the case of FIG. 9, the description of them will be suitably omitted. Further in FIG. 10, each of the straight lines CA14-1 to CA14-12 represents a sound pressure estimation candidate point, and the polygonal line ETM 14 represents the estimated sound pressure in each frame.

In this example, the frames of the positions denoted by arrows NZ11 to NZ13, that is, the frames which include a sudden noise, are not selected as sound pressure estimation candidate points, and the frames of sections of a voice, which are denoted by the hatched rectangles on the bottom part in the figure, are made sound pressure estimation candidate points. As a result of this, the estimated sound pressure denoted by the polygonal line ETM14 becomes appropriately larger for the sections of the voice.

In this way in recording level automatic setting device 43, since the sound pressure estimation candidate points are updated for each frame, so that an appropriate frame is selected as a sound pressure estimation candidate point by the sound pressure estimation candidate point updating process, an appropriate estimated sound pressure can be obtained. Therefore, a target gain with a higher accuracy can be obtained, and an output voice signal of an appropriate level can be obtained.

### The Second Embodiment

Next, another specific embodiment applicable to the present disclosure will be described.

The configuration example of the second embodiment of a voice processing system applicable to the present disclosure is the same as the configuration example of the first embodiment shown in FIG. 4, and parts which are different from those of the first embodiment will be hereinafter described in detail.

In the above described first embodiment, in the case where although there is a sudden noise, judgment of a sudden noise does not correctly work, and where a frame has been made one of the sound pressure estimation candidate points, there will be a significant effect on the estimated sound pressure est_rms(n) calculated in the sound pressure estimation section, since this frame has a high sound pressure level from the standpoint of the characteristics of a sudden noise. Specifically, the estimated sound pressure est_rms(n) is calculated larger than the actual sound pressure, and the gain calculated in the gain calculation section as a result of this becomes small. Further, since the feature quantities of a frame with a high sound pressure level are retained in the sound pressure estimation candidate point updating section, the feature quantities of a frame which includes a sudden noise will be present in the sound pressure estimation candidate points until the maximum hold time has elapsed, that is, a state will be maintained in which the gain is small.

In order to avoid such an effect, when an estimated sound pressure est_rms(n) is obtained in the sound pressure estimation section, the second embodiment based on the present disclosure excludes an upper given ratio, which sorts the sound pressure estimation candidate points in the order from the largest sound pressure level, from the calculation of the estimated sound pressure est_rms(n), and obtains an estimated sound pressures est_rms(n) from the other sound pressure estimation candidate points.

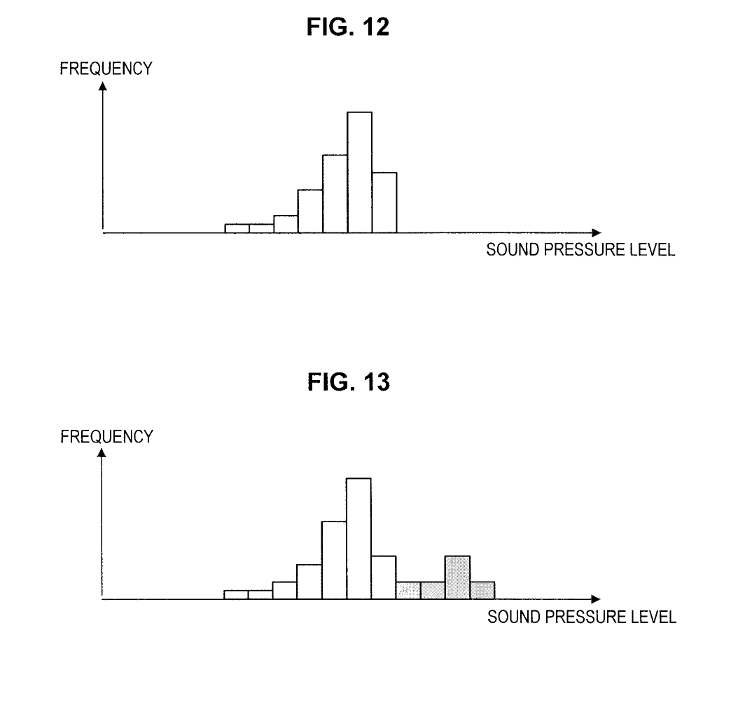

FIG. 12 is a typical example of a sound pressure level histogram based on the present disclosure, on account of obtaining a histogram of the sound pressure levels from all the sound pressure estimation candidate points retained at the time of processing.

FIG. 13 shows an example of a sound pressure level histogram, in the case where an omission has occurred in the detection of a sudden noise, and a frame which includes a sudden noise is included in the sound pressure estimation candidate points. The grey colored bins signify the cause of the sudden noise. As shown in FIG. 13, in order to exclude sudden noise of high sound pressure levels, such as those which affect the sound pressure estimation, from the sound pressure estimation, the present embodiment sorts the sound pressure estimation candidate points in the sound pressure estimation section in the order of the sound pressure level, and calculates the estimated sound pressure est_rms(n) while excluding a number of sound pressure estimation candidate points of the upper given ratio from the calculation. Here, how the ratio, which is excluded from the calculation of this estimated sound pressure, is set is preferably determined while considering such things as the detection performance when judging sudden noise in the sound pressure estimation candidate point updating section, and the change of the estimated sound pressure est_rms(n) when performing the calculation while excluding the upper given ratio in the case where a sudden noise is not present.

Here, since a calculation cost has to be taken into consideration for sorting the sound pressure estimation candidate points in each frame in the order of the sound pressure level such as described above, another embodiment based on the present embodiment can adopt a method which includes ranking information of the sound pressure levels among all of the sound pressure estimation candidate points in one feature quantity of the retained sound pressure candidate points, and performs an update of the ranking information when new sound pressure estimation candidate points are incorporated into the sound pressure estimation candidate point updating section.

### The Third Embodiment

Next, a further specific embodiment applicable to the present disclosure will be described.

The configuration example of the third embodiment of a voice processing system applicable to the present disclosure is the same as the configuration example of the first embodiment shown in FIG. 4, and parts which are different from those of the first embodiment will be hereinafter described in detail.

In the above described first embodiment, a method was possible which uses sudden noise information, calculated in the feature quantity calculation section and retained as one of the feature quantities of the sound pressure estimation candidate points, for the sound pressure estimation in the sound pressure estimation section, as another countermeasure against detection omissions of a sudden noise.

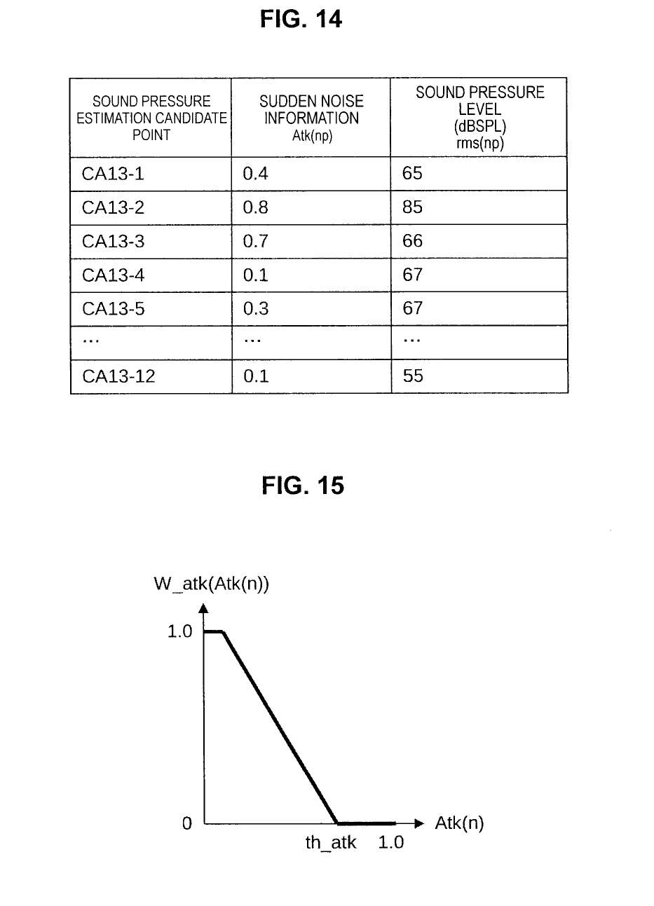

FIG. 14 shows an example of values of sudden noise information and a sound pressure level in an example of each of the sound pressure estimation candidate points shown by FIG. 9. From the description of the above described first embodiment, a predetermined threshold th_atk for judging whether or not the current frame is a section of a sudden noise has here a provisional value of 0.9. In this case, it is judged that all the sound pressure estimation candidate points of CA13-1 to CA13-5 and CA13-12 shown in FIG. 14 do not have a sudden noise.

For such a case, in order to avoid calculating an estimated sound pressure est_rms(n) larger than the actual sound pressure due to a detection omission of a sudden noise, the sound pressure estimation section in the third embodiment calculates the estimated sound pressure est_rms(n) by using a weighting w_atk(Atk(nₚ), such that the value becomes smaller as the sudden noise information becomes larger.

FIG. 15 is a figure which shows an example of the weighting w_atk(Atk(nₚ) for the sudden noise information Atk(nₚ). The horizontal axis shows the sudden noise information Atk(nₚ), and the vertical axis shows the weighting w_atk(Atk(nₚ). The calculation of the estimated sound pressure est_rms(n) which uses this weighting can be calculated by using Equations (7) and (8), as described above in the first embodiment.

Incidentally, the above mentioned series of processes can be executed by hardware, or can be executed by software. In the case where the series of processes is executed by software, a program configuring this software is installed in a computer. Here, a computer incorporated into specialized hardware, and a general-purpose personal computer, which is capable of executing various functions by installing various programs, are included in the computer.

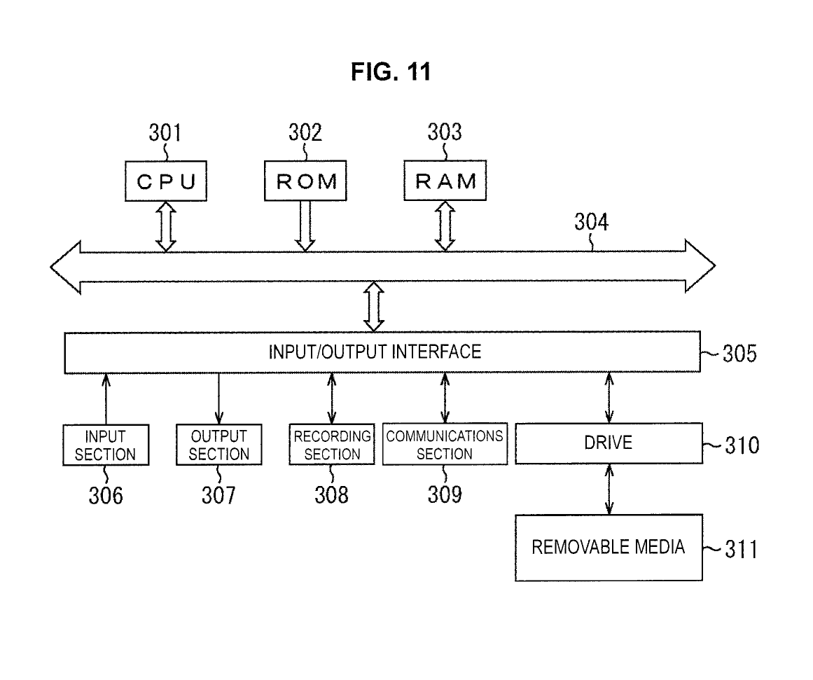

FIG. 11 is a block diagram which shows an example configuration of hardware of the computer which executes the above mentioned series of processes by a program.

In the computer, a CPU (Central Processing Unit) 301, a ROM (Read Only Memory) 302, and a RAM (Random Access Memory) 303 are mutually connected by a bus 304.

An input/output interface 305 is further connected to the bus 304. An input section 306, an output section 307, a recording section 308, a communications section 309, and a drive 310 are connected to the input/output interface 305.

The input section 306 includes a keyboard, a mouse, a microphone or the like. The output section 307 includes a display, a speaker or the like. The recording section 308 includes a hard disk, a nonvolatile memory or the like. The communications section 309 includes a network interface or the like. The drive 310 drives a removable media 311, such as a magnetic disk, an optical disk, a magneto-optical disk, or a semiconductor memory.

In a computer configured such as above, the above mentioned series of processes are performed, for example, by the CPU 301 loading a program, which is recorded in the recording section 308, in the RAM 303, and executing the program through the input/output interface 305 and the bus 304.

The program executed by the computer (CPU 301) can be, for example, recorded and provided in a removable media 311 as packaged media or the like. Further, the program can be provided through a wired or wireless transmission medium, such as a local area network, the internet, or digital satellite broadcasting.

In the computer, the program can be installed in the recording section 308 through the input/output interface 305, by mounting the removable media 311 in the drive 310. Further, the program can be received by the communications section 309 through the wired or wireless transmission medium, and can be installed in the recording section 308. Additionally, the program can be installed beforehand in the ROM 302 or the recording section 308.

Note that the program executed by the computer may be a program which performs time series processes, in accordance with the order described in the present disclosure, or may be a program which performs the processes at a necessary timing, such as when calling is performed in parallel.

It should be understood by those skilled in the art that various modifications, combinations, sub-combinations and alterations may occur depending on design requirements and other factors insofar as they are within the scope of the appended claims or the equivalents thereof.

For example, the present disclosure can adopt a configuration of cloud computing, which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below.

(1) A voice processing apparatus, including:

a feature quantity calculation section which extracts a feature quantity from a target frame of an input voice signal;

a sound pressure estimation candidate point updating section which makes each of a plurality of frames of the input voice signal a sound pressure estimation candidate point, retains the feature quantity of each sound pressure estimation candidate point, and updates the sound pressure estimation candidate point based on the feature quantity of the sound pressure estimation candidate point and the feature quantity of the target frame;

a sound pressure estimation section which calculates an estimated sound pressure of the input voice signal, based on the feature quantity of the sound pressure estimation candidate point;

a gain calculation section which calculates a gain applied to the input voice signal based on the estimated sound pressure; and

a gain application section which performs a gain adjustment of the input voice signal based on the gain.

(2) The voice processing apparatus according to (1),

wherein the feature quantity calculation section calculates a peak value of an amplitude of the input voice signal, in at least the target frame, as the feature quantity, and

wherein, when the peak value of the target frame is larger than a minimum value of the peak value as the feature quantity of the sound pressure estimation candidate point, the sound pressure estimation candidate point updating section discards the sound pressure estimation candidate point having the minimum value, and makes the target frame a new sound pressure estimation candidate point.

(3) The voice processing apparatus according to (1) or (2),

wherein the feature quantity calculation section calculates sudden noise information indicative of a likeliness of a sudden noise in at least the target frame, as the feature quantity, and

wherein, when the target frame is a section including the sudden noise based on the sudden noise information, the sound pressure estimation candidate point updating section does not make the target frame the sound pressure estimation candidate point.

(4) The voice processing apparatus according to (2),

wherein, when a shortest frame interval of frame intervals between adjacent sound pressure estimation candidate points is less than a predetermined threshold, the sound pressure estimation candidate point updating section discards the sound pressure estimation candidate point having a small peak value from the adjacent sound pressure estimation candidate points having the shortest frame interval, and makes the target frame the new sound pressure estimation candidate point.

(5) The voice processing apparatus according to (4),

wherein the predetermined threshold is determined in a manner that the predetermined threshold increases with passage of time.

(6) The voice processing apparatus according to any one of (1) to (5),

wherein the feature quantity calculation section calculates a number of elapsed frames, at least from the sound pressure estimation candidate point up to the target frame, as the feature quantity, and

wherein, when a maximum value of the number of elapsed frames of the sound pressure estimation candidate point is larger than a predetermined number of frames, the sound pressure estimation candidate point updating section discards the sound pressure estimation candidate point having the maximum value, and makes the target frame the new sound pressure estimation candidate point.

(7) The voice processing apparatus according to any one of (1) to (6),

wherein the input voice signal is input to the voice processing apparatus, the input voice signal being obtained through a gain adjustment by an amplification section and conversion from an analogue signal to a digital signal, and

wherein the gain calculation section calculates the gain used for the gain adjustment in the gain application section and the gain used for the gain adjustment in the amplification section, based on the calculated gain.

The present disclosure contains subject matter related to that disclosed in Japanese Priority Patent Application JP 2012-012864 filed in the Japan Patent Office on Jan. 25, 2012, the entire content of which is hereby incorporated by reference.

What is claimed is:

1. A voice processing apparatus, comprising:
a feature quantity calculation section which extracts a feature quantity from a target frame of an input voice signal;
a sound pressure estimation candidate point updating section which makes each of a plurality of frames of the input voice signal a sound pressure estimation candidate point, retains the feature quantity of each sound pressure estimation candidate point, and updates the sound pressure estimation candidate point based on the feature quantity of the sound pressure estimation candidate point and the feature quantity of the target frame;
a sound pressure estimation section which calculates an estimated sound pressure of the input voice signal, based on the feature quantity of the sound pressure estimation candidate point;
a gain calculation section which calculates a gain applied to the input voice signal based on the estimated sound pressure; and
a gain application section which performs a gain adjustment of the input voice signal based on the gain.

2. The voice processing apparatus according to claim 1,
wherein the feature quantity calculation section calculates a sound pressure level of the input voice signal, in at least the target frame, as the feature quantity, and
wherein, when the sound pressure level of the target frame is larger than a minimum value of the sound pressure level as the feature quantity of the sound pressure estimation candidate point, the sound pressure estimation candidate point updating section discards the sound pressure estimation candidate point having the minimum value, and makes the target frame a new sound pressure estimation candidate point.

3. The voice processing apparatus according to claim 2,
wherein the feature quantity calculation section calculates sudden noise information indicative of a likeliness of a sudden noise in at least the target frame, as the feature quantity, and
wherein, when the target frame is a section including the sudden noise based on the sudden noise information, the sound pressure estimation candidate point updating section does not make the target frame the sound pressure estimation candidate point.

4. The voice processing apparatus according to claim 2,
wherein, when a shortest frame interval of frame intervals between adjacent sound pressure estimation candidate points is less than a predetermined threshold, the sound pressure estimation candidate point updating section discards the sound pressure estimation candidate point having a small sound pressure level from the adjacent sound pressure estimation candidate points having the shortest frame interval, and makes the target frame the new sound pressure estimation candidate point.

5. The voice processing apparatus according to claim 4,
wherein the predetermined threshold is determined in a manner that the predetermined threshold increases with passage of time.

6. The voice processing apparatus according to claim 2,
wherein the feature quantity calculation section calculates a number of elapsed frames, at least from the sound pressure estimation candidate point up to the target frame, as the feature quantity, and
wherein, when a maximum value of the number of elapsed frames of the sound pressure estimation candidate point is larger than a predetermined number of frames, the sound pressure estimation candidate point updating section discards the sound pressure estimation candidate point having the maximum value, and makes the target frame the new sound pressure estimation candidate point.

7. The voice processing apparatus according to claim 2,
wherein the input voice signal is input to the voice processing apparatus, the input voice signal being obtained through a gain adjustment by an amplification section and conversion from an analogue signal to a digital signal, and
wherein the gain calculation section calculates the gain used for the gain adjustment in the gain application section and the gain used for the gain adjustment in the amplification section, based on the calculated gain.

8. The voice processing apparatus according to claim 1,
wherein the sound pressure estimation section performs an estimation of a sound pressure by excluding, in order from a largest sound pressure level, a given ratio number of sound pressure estimation candidate points from the sound pressure estimation candidate points.

9. The voice processing apparatus according to claim 1,
wherein the feature quantity calculation section calculates sudden noise information indicative of a likeliness of a sudden noise in at least the target frame, as the feature quantity, and
wherein the sound pressure estimation section performs an estimation of a sound pressure, based on the sudden noise information and the sound pressure level held by the sound pressure estimation candidate point.

10. A voice processing method, comprising:
extracting a feature quantity from a target frame of an input voice signal;
making each of a plurality of frames of the input voice signal a sound pressure estimation candidate point, retaining the feature quantity of each sound pressure estimation candidate point, and updating the sound pressure estimation candidate point based on the feature quantity of the sound pressure estimation candidate point and the feature quantity of the target frame;
calculating an estimated sound pressure of the input voice signal, based on the feature quantity of the sound pressure estimation candidate point;
calculating a gain applied to the input voice signal based on the estimated sound pressure; and
performing a gain adjustment of the input voice signal based on the gain.

11. A program for causing a computer to execute the processes of:
extracting a feature quantity from a target frame of an input voice signal;
making each of a plurality of frames of the input voice signal a sound pressure estimation candidate point, retaining the feature quantity of each sound pressure estimation candidate point, and updating the sound pressure estimation candidate point based on the feature quantity of the sound pressure estimation candidate point and the feature quantity of the target frame;
calculating an estimated sound pressure of the input voice signal, based on the feature quantity of the sound pressure estimation candidate point;
calculating a gain applied to the input voice signal based on the estimated sound pressure; and
performing a gain adjustment of the input voice signal based on the gain.
